(19) United States
(12) Patent Application Publication
(10) Pub. No.: US 2024/0346078 A1
(43) Pub. Date: Oct. 17, 2024

(54) METHOD FOR EMBEDDING GRAPH AND SYSTEM THEREFOR

(71) Applicant: SAMSUNG SDS CO., LTD., Seoul (KR)

(72) Inventors: Jae Sun SHIN, Seoul (KR); Eun Joo JEON, Seoul (KR); Tae Won CHO, Seoul (KR); Nam Kyeong CHO, Seoul (KR)

(73) Assignee: SAMSUNG SDS CO., LTD., Seoul (KR)

(21) Appl. No.: 18/638,253

(22) Filed: Apr. 17, 2024

(30) Foreign Application Priority Data
Apr. 17, 2023 (KR) 10-2023-0049821
Jul. 12, 2023 (KR) 10-2023-0090164

(51) Int. Cl. G06F 16/901; G06T 11/00; G06T 11/20

(52) U.S. Cl. CPC G06F 16/9024; G06T 11/001; G06T 11/206

(57) ABSTRACT

A method for embedding a graph and a system therefor are provided. The method according to some embodiments may include acquiring a colored graph for a target graph, calculating an edge weight for the colored graph based on node color values of the colored graph, generating an edge filtration for the colored graph using the edge weight as a connectivity metric between nodes, and generating an embedding representation of the target graph based on topology information extracted from the edge filtration.

### CROSS-REFERENCE TO RELATED APPLICATION(S)

This application claims priority from Korean Patent Application No. 10-2023-0049821, filed on Apr. 17, 2023, and Korean Patent Application No. 10-2023-0090164, filed on Jul. 12, 2023, in the Korean Intellectual Property Office, and all the benefits accruing therefrom under 35 U.S.C. 119, the contents of which in its entirety are herein incorporated by reference(s).

### BACKGROUND

### 1. Field

The present disclosure relates to a method for embedding a graph and a system therefor.

### 2. Description of the Related Art

Graph embedding refers to the conversion of a given graph into a representation (e.g., a vector or matrix representation) in an embedding space. Recently, research on methods for embedding graphs using neural networks has been actively conducted, and neural networks that handle graphs are referred to as graph neural networks (GNNs).

Meanwhile, most graph embedding techniques utilize GNNs (e.g., a graph isomorphism network (GIN), a provably powerful graph network (PPGN), etc.) based on a neighboring node information aggregation method (i.e., a method of passing messages between nodes). These graph embedding techniques are known to possess the expressive power up to that of the Weisfeiler-Lehman (WL) algorithm (or test). However, the WL algorithm has a clear limitation in that it almost fails to capture topology information of graphs, and its proposed graph embedding techniques share this limitation.

To overcome such limitations, a graph embedding technique that utilizes topology information extracted from node filtrations has recently been proposed. However, this graph embedding technique has another limitation in that it fails to capture graph information covered by the WL algorithm (or a graph embedding technique based on the neighboring node aggregation method) and misses some topology information. In other words, this graph embedding technique also does not provide stronger expressive power than the WL algorithm.

### SUMMARY

Aspects of the present disclosure provide a method and system for accurately generating an embedding representation that reflects topology information of a graph.

Aspects of the present disclosure also provide a method and system for generating an embedding representation with stronger expressive power than the Weisfeiler-Lehman (WL) algorithm (or a graph embedding technique based on a neighboring node aggregation method) and a node filtration-based graph embedding technique.

Aspects of the present disclosure also provide a method and a system that may universally improve the performance of various graph tasks (e.g., graph classification tasks, etc.).

Aspects of the present disclosure also provide a method and system for accurately calculating the weight of edges based on the node color values of a graph.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to an aspect of the present disclosure, there is provided a method for embedding a graph performed by at least one processor. The method may include acquiring a colored graph for a target graph; calculating an edge weight for the colored graph based on node color values of the colored graph; generating an edge filtration for the colored graph using the edge weight as a connectivity metric between nodes; and generating an embedding representation of the target graph based on topology information extracted from the edge filtration.

In some embodiments, the colored graph may be generated by updating a color value of each node that forms the target graph, in a manner that aggregates color values of neighboring nodes.

In some embodiments, the calculating the edge weight may include: generating a line graph corresponding to the colored graph, node color values of the line graph being determined based on color values of a node tuple connected by a corresponding edge in the colored graph; and calculating an edge weight for a first edge of the colored graph corresponding to a first node in the line graph based on a color value of the first node.

In some embodiments, the calculating the edge weight for the first edge may include determining the edge weight for the first edge based on an output value of a predictor that is obtained by inputting the color value of the first node, and the predictor may be configured to output a score indicating whether an edge of the colored graph corresponding to an input node is an actual edge or a virtual edge, based on a color value of the input node.

In some embodiments, a training process of the predictor may include: generating an expanded line graph by adding a virtual node and a virtual edge to a training line graph; calculating a score, based on a color value of each node in the expanded line graph, indicating whether a corresponding edge in the expanded line graph is an actual edge or a virtual edge; and updating the predictor based on a loss associated with the calculated score.

In some embodiments, the expanded line graph is a complete line graph.
the generating the line graph may include: acquiring a mapping color value for color values of a first node tuple connected by the first edge through a color value mapping module; and assigning the mapping color value to the first node, and the color value mapping module may be configured to output the same color value as a particular mapping color value mapped to particular color values when the color values of the first node tuple are equal to the particular color values, and to output a different color value from the particular mapping color value when the color values of the first node tuple are different from the particular color values.

In some embodiments, the generating the line graph may include: calculating a first color value according to Equation 1 below and a second color value according to Equation 2 from color values of a first node tuple connected by the first edge; determining a mapping color value for the first node tuple based on the first and second color values; and assigning the mapping color value to the first node, and

$$c 1 = ( x + η \cdot m ( x ) + y + η \cdot m ( y ) ) \qquad [ Equation 1 ]$$

$$c 2 = ( \vert x + η \cdot m ( x ) - y - η \cdot m ( y ) \vert ) \qquad [ Equation 2 ]$$

where c1 and c2 are the first color value and the second color value, respectively, x and y are the color values of the first node tuple, n denotes a scalar value, which is a real number, and m represents a multi-layer perceptron.

In some embodiments, the calculating the edge weight for the colored graph may include: generating a line graph corresponding to the colored graph, node color values of the line graph being determined based on color values of node tuples connected by corresponding edges in the colored graph; generating an expanded line graph by adding a virtual node and a virtual edge to the line graph; updating a node color value of the expanded line graph by aggregating color values of neighboring nodes; and calculating an edge weight for a first edge of the colored graph corresponding to a first node in the expanded line graph based on the updated color value of the first node.

In some embodiments, the generating the edge filtration may include generating the edge filtration using a Vietoris-Rips filtration technique.

In some embodiments, the generating the embedding representation of the target graph may include extracting the topology information by calculating a persistence diagram based on the edge filtration.

In some embodiments, the topology information may be information in a form of a multi-set, and the generating the embedding representation of the target graph further may include generating the embedding representation of the target graph by encoding the topology information through a neural network-based encoder equipped with an embedding capability for the multi-set.

In some embodiments, the generating the embedding representation of the target graph may include: deriving a first intermediate embedding representation for the target graph based on the topology information; deriving a second intermediate embedding representation for the target graph based on the node color values of the colored graph; and generating the embedding representation of the target graph by aggregating the first intermediate embedding representation and the second intermediate embedding representation.

In some embodiments, the generating the embedding representation of the target graph by aggregating the first and second intermediate embedding representations may include aggregating the first intermediate embedding representation and the second intermediate embedding representation by reflecting a specific value in at least one of the first intermediate embedding representation and the second intermediate embedding representation, and the specific value is an irrational number.

In some embodiments, the generating the embedding representation of the target graph by aggregating the first and second intermediate embedding representations may include aggregating the first intermediate embedding representation and the second intermediate embedding representation by reflecting a specific value in at least one of the first intermediate embedding representation and the second intermediate embedding representation, the specific value is based on a learnable parameter, and a value of the learnable parameter is updated by performing a predefined task based on the generated embedding representation.

In some embodiments, the method may further include: calculating a task loss by performing a predefined task based on the generated embedding representation; and updating values of parameters involved in the generating the embedding representation based on the task loss.

According to another aspect of the present disclosure, there is provided a system for embedding a graph. The system may include: at least one processor; and a memory configured to store a computer program that is executed by the at least one processor, wherein the computer program includes instructions for performing: acquiring a colored graph for a target graph; calculating an edge weight for the colored graph based on node color values of the colored graph; generating an edge filtration for the colored graph using the edge weight as a connectivity metric between nodes; and generating an embedding representation of the target graph based on topology information extracted from the edge filtration.

According to yet another aspect of the present disclosure, there is provided a non-transitory computer-readable recording medium having stored therein a computer program executing a method for embedding a graph, the method including: acquiring a colored graph for a target graph; calculating an edge weight for the colored graph based on node color values of the colored graph; generating an edge filtration for the colored graph using the edge weight as a connectivity metric between nodes; and generating an embedding representation of the target graph based on topology information extracted from the edge filtration.

### BRIEF DESCRIPTION OF THE DRAWINGS

The above and other aspects and features of the present disclosure will become more apparent by describing in detail example embodiments thereof with reference to the attached drawings, in which:

FIG. 1 is an example diagram for briefly explaining operations of a graph embedding system according to some embodiments of the present disclosure;

FIG. 2 is a diagram illustrating a pair of graphs that the Weisfeiler-Lehman (WL) algorithm may not distinguish between;

FIG. 3 is a diagram illustrating a pair of graphs that a node filtration-based graph embedding technique may not distinguish between;

FIG. 4 is an example diagram for briefly explaining other operations of the graph embedding system according to some embodiments of the present disclosure;

FIG. 5 is an example flowchart illustrating a graph embedding method according to some embodiments of the present disclosure;

FIG. 6 is an example diagram for explaining the step of acquiring a colored graph, as performed in the graph embedding method of FIG. 5;

FIGS. 7 and 8 are example diagrams for explaining the concepts of node filtration and edge filtration, which may be referenced in various embodiments of the present disclosure;

FIGS. 9 and 10 are example diagrams for explaining the limitations of node filtration and why edge filtration has been adopted over node filtration;

FIGS. 11 and 12 are example diagrams for explaining the step of generating edge filtrations as performed in the graph embedding method of FIG. 5;

FIG. 13 is an example diagram for explaining the step of generating an embedding representation as performed in the graph embedding method of FIG. 5;

FIG. 14 is an example flowchart illustrating a method of calculating edge weights according to some embodiments of the present disclosure;

FIG. 15 is an example diagram for explaining the step of generating a line graph, as performed in the method of FIG. 14;

FIG. 16 is an example diagram for explaining an operation of a color value mapping module according to some embodiments of the present disclosure;

FIG. 17 is an example diagram for explaining the step of generating an expanded line graph as performed in the method of FIG. 14;

FIGS. 18 and 19 are example diagrams for explaining the steps of updating node color values and calculating edge weights as performed in the method of FIG. 14;

FIG. 20 is an example diagram for explaining the graph embedding method according to some embodiments of the present disclosure;

FIG. 21 is an example diagram for explaining a graph embedding method according to other embodiments of the present disclosure;

FIG. 22 illustrates a pair of graphs that a provably powerful graph network (PPGN) may not distinguish between; and

FIG. 23 is a hardware configuration view illustrating an example computing device that may implement the document comparison system according to some embodiments of the present disclosure.

### DETAILED DESCRIPTION

Hereinafter, example embodiments of the present disclosure will be described with reference to the attached drawings. Advantages and features of the present disclosure and methods of accomplishing the same may be understood more readily by reference to the following detailed description of example embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that may be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), may be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Embodiments of the present disclosure will be described with reference to the attached drawings.

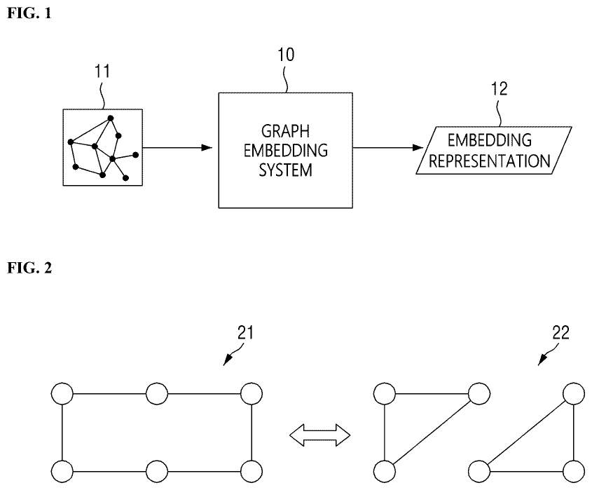

FIG. 1 is an example drawing for explaining operations of a graph embedding system 10 according to some embodiments of the present disclosure.

Referring to FIG. 1, the graph embedding system 10 is a computing device/system capable of generating an embedding representation 12 for a graph 11. For example, the graph embedding system 10 may generate an embedding representation 12 with strong expressive power based on topology information of the graph 11. Here, the topology information may include, without limitation, various information regarding the shape, structure, and/or connectivity of the graph 11. For convenience, the graph embedding system 10 will be hereinafter referred to as the “embedding system 10.”

The embedding representation 12 means a representation in an embedding space for the graph 11 and may be in the form of, for example, a vector or matrix representation. Here, the term “matrix” may encompass the concept of a tensor. The embedding representation 12 may also be referred to as an embedding vector, embedding matrix, or embedding code, or may be simply abbreviated as “embedding” or “representation.”

Specifically, the embedding system 10 may extract topology information from edge filtrations of the representation 12 and may generate the embedding representation 12 of the graph 11 based on the extracted topology information. In this manner, an embedding representation 12 with stronger expressive power than the Weisfeiler-Lehman (WL) algorithm (or test) may be generated. Here, having stronger expressive power than the WL algorithm means that the embedding representation 12 has stronger expressive power than both an embedding representation generated by the WL algorithm (or a graph embedding technique based on a neighboring node aggregation method) and an embedding representation generated by a node filtration-based graph embedding technique.

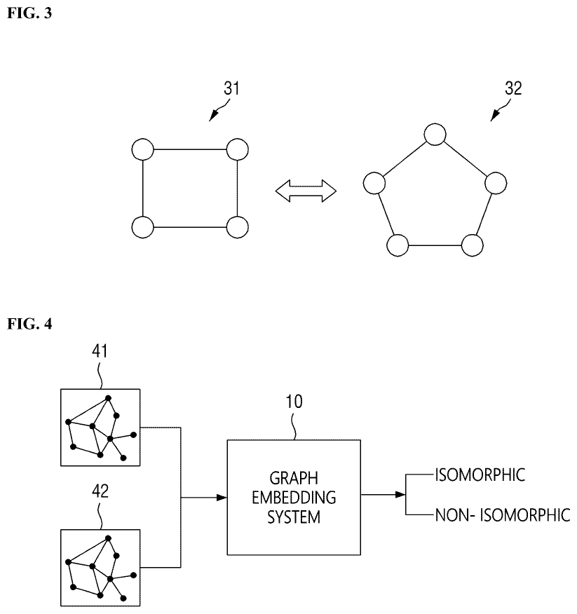

More specifically, while the node filtration-based graph embedding technique may distinguish between a pair of graphs 21 and 22 of FIG. 2 by generating different embedding representations for the graphs 21 and 22 and determining the graphs 21 and 22 as being non-isomorphic, the WL algorithm may not distinguish the graphs 21 and 22 because it generates the same embedding representation for both the graphs 21 and 22. Conversely, the node filtration-based graph embedding technique may not distinguish between a pair of graphs 31 and 32 of FIG. 3, whereas the WL algorithm may distinguish the graphs 31 and 32. Thus, it may not be said that the node filtration-based graph embedding technique provides stronger expressive power than the WL algorithm, and vice versa.

However, the embedding representation 12 generated by the embedding system 10 may distinguish both the graphs 21 and 22 of FIG. 2 and the graphs 31 and 32 of FIG. 3. In this regard, the embedding representation 12 may be understood as having stronger expressive power than embedding representations generated by the WL algorithm and the node filtration-based graph embedding technique.

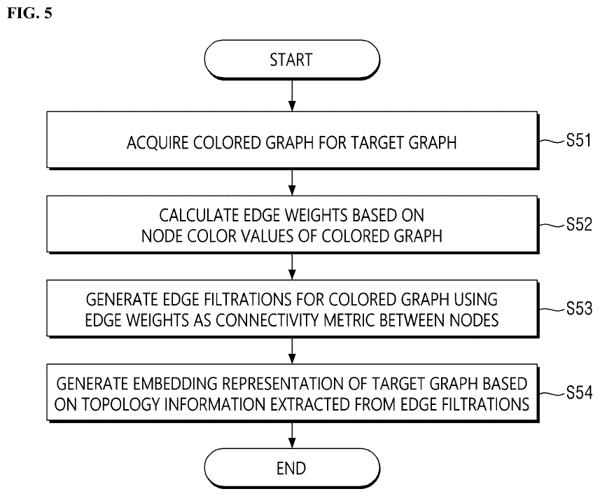

It will hereinafter be described how the embedding system 10 generates the embedding representation 12 with reference to FIG. 5 and the subsequent figures.

Additionally, the embedding system 10 may perform various graph tasks such as a classification task, regression task, graph distinction task, etc., using the embedding representation 12 of the graph 11. For example, Referring to FIG. 4, the embedding system 10 may perform tasks such as distinguishing between two graphs 41 and 44, determining whether or not the two graphs 41 and 44 are isomorphic, as will be described later with reference to the experimental example in Table 1, and may also perform other graph tasks such as a classification task and regression task, as will be described later with reference to the experimental examples in Tables 2 and 3. In some embodiments, the embedding system 10 may provide the embedding representation 12 to a separate task execution device (not illustrated).

The embedding system 10 may be implemented as at least one computing device. For example, all functionalities of the embedding system 10 may be implemented on a single computing device, or first and second functionalities of the embedding system 10 may be implemented on first and second computing devices, respectively. Alternatively, a particular functionality of the embedding system 10 may be implemented across multiple computing devices.

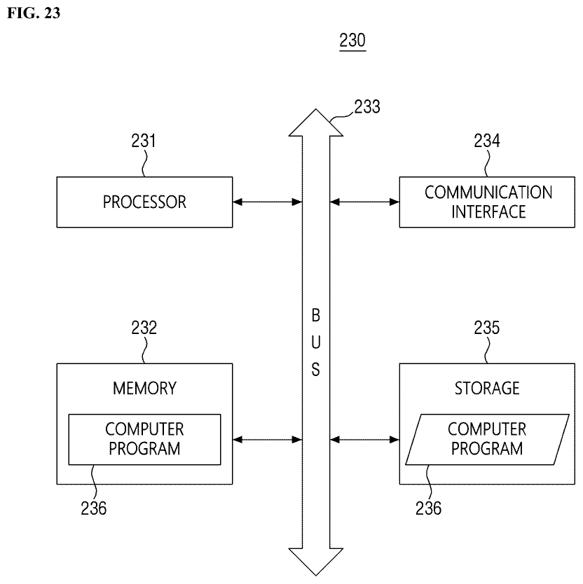

Here, the term “computing device” may include any device equipped with computing capabilities, and an example of such device is as illustrated in FIG. 23. Since a computing device is an assembly where various components (e.g., a memory, processor, etc.) interact, it may also be referred to as a computing system. Obviously, the term “computing system” may also encompass the concept of an assembly where multiple computing devices interact.

So far, the operation of the embedding system 10 has been briefly explained with reference to FIGS. 1 through 4. Various methods that may be performed in the embedding system 10 will hereinafter be described with reference to FIG. 5 and the subsequent figures.

For ease of understanding, it is assumed that in the description that follows, all steps/operations of methods that will hereinafter be described are performed by the embedding system 10. Therefore, if the subject of a particular step/operation is omitted, it may be understood to be performed by the embedding system 10. However, in actual environments, some steps/operations of the methods that will hereinafter be described may be performed by other computing devices/systems.

Furthermore, for clarity, reference numbers may be omitted when not directly referencing the drawings, and even if they refer to the same components, they may change from one embodiment to another.

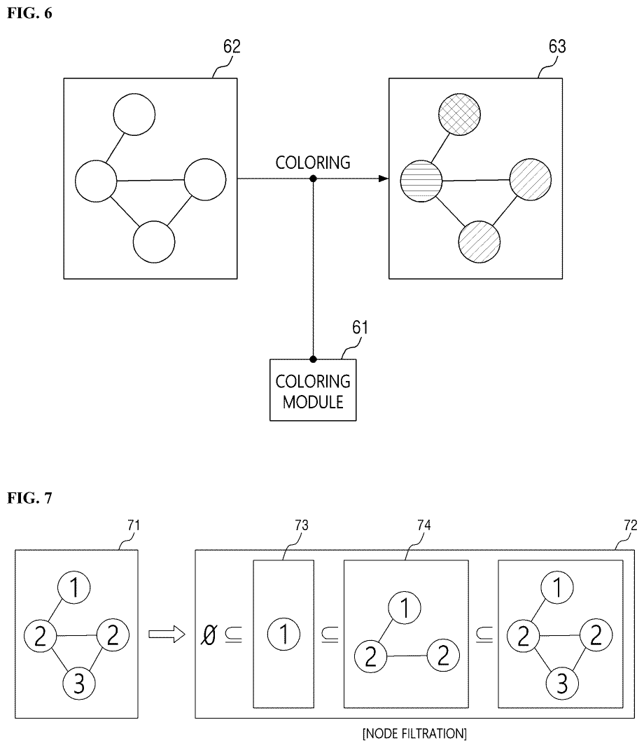

FIG. 5 is an example flowchart illustrating a graph embedding method according to some embodiments of the present disclosure. The graph embedding method of FIG. 6 is merely a preferred embodiment for achieving the objectives of the present disclosure, and it is understood that some steps may be added or omitted, as necessary.

Referring to FIG. 5, the graph embedding method may start with step S51, which is the step of acquiring a colored graph for a target graph. The target graph, which is a graph to be embedded, may be a training-stage graph for use in embedding training or an inference-stage graph. The colored graph refers to a graph where each node is assigned a color value through coloring.

For example, referring to FIG. 6, an embedding system 10 may generate a colored graph 63 by performing a coloring process on a target graph 62 through a coloring module 61. Here, the coloring process may involve iteratively updating each node's color value by aggregating the color values of neighboring nodes (or passing messages between nodes).

For reference, the color value (or color information) of each node may also be referred to as a feature (or feature information), label (or label information), signature, or node embedding.

For example, the embedding system 10 may perform coloring by inputting an adjacent matrix to the target graph 62 and feature data of the nodes of the target graph 62 (e.g., a feature matrix composed of the feature vectors of the nodes) into a graph neural network (GNN) based on the neighboring node aggregation method. That is, the coloring module 61 may be a GNN-based module. Examples of the GNN include a graph isomorphism network (GIN), a provably powerful graph network (PPGN), but the present disclosure is not limited thereto. The GIN, which is a GNN that implements a node color value update operation of the WL algorithm as a multilayer perceptron (MLP), is known to have the same expressive power as the WL algorithm. The structure and operating principles of the GIN are already well known to one of ordinary skill in the art to which the present disclosure pertains, and thus, detailed descriptions thereof will be omitted. The GNN (or the coloring module 61) may or may not be pre-trained. Additionally, the GNN may or may not be trained (or updated) during an embedding training stage along with other modules.

In another example, the embedding system 10 may set the feature data (e.g., feature vectors) of the nodes of the target graph 62 as initial color values and perform coloring through the WL algorithm. In this example, the coloring module 61 may be a module that performs the WL algorithm. The WL algorithm refers to a technique of iteratively updating each node's color value based on the color values of neighboring nodes until each node's partition state (i.e., color state) becomes stable. The WL algorithm is already well known to one of ordinary skill in the art to which the present disclosure pertains, and thus, a detailed description thereof will be omitted.

In yet another example, coloring of the target graph 62 may be performed based on various combinations of the aforementioned examples.

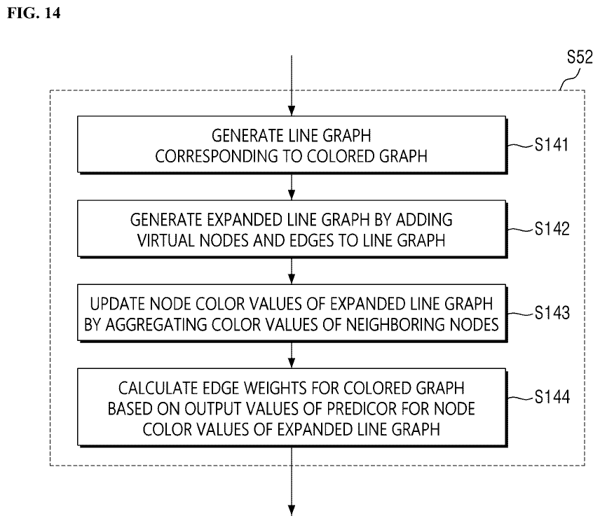

Referring back to FIG. 5, in step S52, edge weights for the colored graph may be calculated based on the node color values of the colored graph. The edge weights may be used as a connectivity metric to generate edge filtrations. The concept of the term “edge filtration” will be described later, and the details of step S52 will also be explained later in detail with reference to FIGS. 14 through 19. In the following description, a colored graph with assigned edge weights may be referred to as a color-weighted graph.

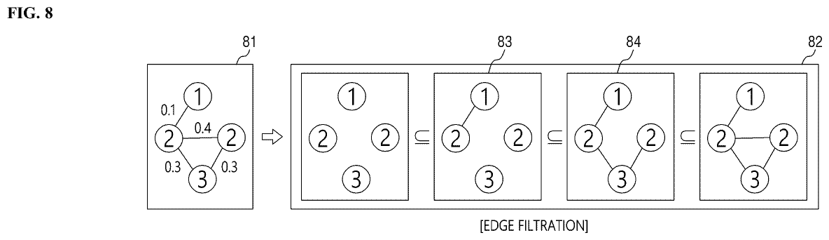

In step S53, edge filtrations for the target graph may be generated using the edge weights as a connectivity metric between the nodes. Here, the term “filtration” refers to a collection or sequence of subgraphs that represent an evolutionary process of a graph (particularly, a simplicial complex), where the subgraphs have an inclusion relationship in one direction (i.e., an increasing direction) (see FIGS. 7 and 8 for reference).

Specifically, a node filtration refers to a collection of subgraphs that represent the evolutionary process of a graph based on nodes (i.e., a collection of subgraphs that have an inclusion relationship in a direction where the number of nodes increases). For example, referring to FIG. 7, a node filtration 72 of a graph 71 consists of subgraphs 73 and 74 that represent an evolutionary process in the direction where the number of nodes increases, and there is an inclusion relationship between the subgraphs 73 and 74.

Similarly, an edge filtration refers to a collection of subgraphs that represent an evolutionary process of a graph based on edges (i.e., a collection of subgraphs that have an inclusion relationship in a direction where the number of edges increases). For example, referring to FIG. 8, an edge filtration 82 of a graph 81 consists of subgraphs 83 and 84 that represent an evolutionary process in the direction where the number of edges increases, and there is also an inclusion relationship between the subgraphs 83 and 84.

The concept of “filtration” is already well known to one of ordinary skill in the art to which the present disclosure pertains, and thus, a detailed description thereof will be omitted.

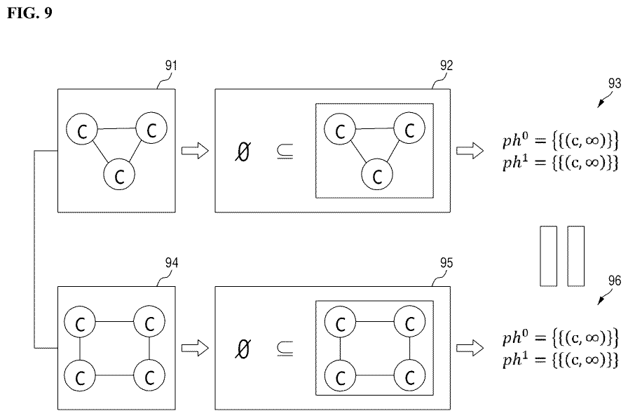

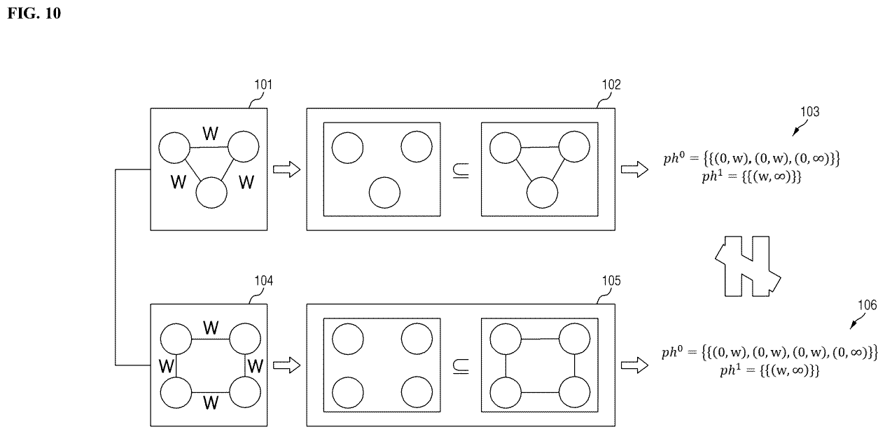

For ease of understanding, the limitations of node filtrations and the reasons for adopting edge filtrations (i.e., the reasons for extracting topology information from edge filtrations) will hereinafter be described with reference to FIGS. 9 and 10.

Referring to FIG. 9, it is assumed that there are two non-isomorphic graphs, i.e., first and second graphs 91 and 94 where all nodes have the same color value, i.e., a color value c. Furthermore, it is also assumed that node filtrations 92 and 95 are generated for the first and second graphs 91 and 94, respectively, using the color value c as a connectivity metric, and persistence homology is calculated in each of the node filtrations 92 and 95 to extract topology information 93 and 96.

In this case, despite the differences between the first and second graphs 91 and 94 and between the node filtrations 92 and 95, the extracted topology information 93 and 96 may be identical, (resulting in the generation of the same embedding representation, making it impossible to accurately distinguish between the first and second graphs 91 and 94). This indicates that using node filtrations may not always accurately capture the topological (or structural) features (information) of a graph.

In FIG. 9, “ph⁰={{(c, ∞)}}” means that when the value of a parameter for generating filtration reaches c, connections (or edges) are generated between nodes and do not disappear even if the value of the parameter increases (assuming that connections are established between nodes with a color value less than or equal to the value of the parameter). Similarly, “ph¹={{(c, ∞)}}” means that when the value of the parameter reaches c, loops (or cycles) are generated between nodes and do not disappear even if the value of the parameter increases.

Conversely, by using edge filtrations 102 and 105 of FIG. 10, different topology information 103 and 106 may be extracted from first and second graphs 101 and 104 of the same structures as the first and second graphs 91 and 94, respectively, of FIG. 9. In this case, different embedding representations may be generated, allowing for accurate distinction between the first and second graphs 101 and 104.

Specifically, referring to FIG. 10, it is assumed that there are the graphs 101 and 104 with the same structures as the first and second graphs 91 and 94, respectively, of FIG. 9, and that the same edge weight (i.e., w) is assigned to all edges of the first and second graphs 101 and 104. Furthermore, it is assumed that edge filtrations 102 and 105 are generated for the graphs 101 and 104, respectively, using the edge weight w as a connectivity metric, and persistence homology is calculated in each of the edge filtrations 102 and 105 to extract topology information 103 and 106.

In this case, the topology information 103 of the first graph 101 and the topology information 106 of the second graph 104 are different (e.g., “ph⁰” differs between the first and second graphs 101 and 104). This indicates that using edge filtrations may accurately capture the topological (or structural) features (or information) of a graph, even including those topological details that node filtrations may miss.

In FIG. 10, “ph⁰={{(0, w), (0, w), (0, 00)}} means that for the first and second nodes of the first graph 101, the value of the parameter appears when it is 0 and then disappears when it is w (i.e., the elements of the set correspond to nodes) and for the third node in the first graph 101, the value of the parameter appears when it is 0, but does not disappear as the value of the parameter increases (because when the value of the parameter is w, connections are created between the three nodes, merging the three nodes into one node, which means that two of the three nodes have disappeared and only one of the three nodes persists). Additionally, “ph¹={{(w, ∞)}}” means that when the value of the parameter reaches w, loops (or cycles) are generated between nodes and do not disappear even as the value of the parameter increases.

As mentioned, since edge filtrations (e.g., the edge filtration 102) may capture topology information that is not obtainable through node filtrations (e.g., the node filtration 92), topology information may be extracted from edge filtrations.

Meanwhile, the method to generate edge filtrations in step S53 may vary.

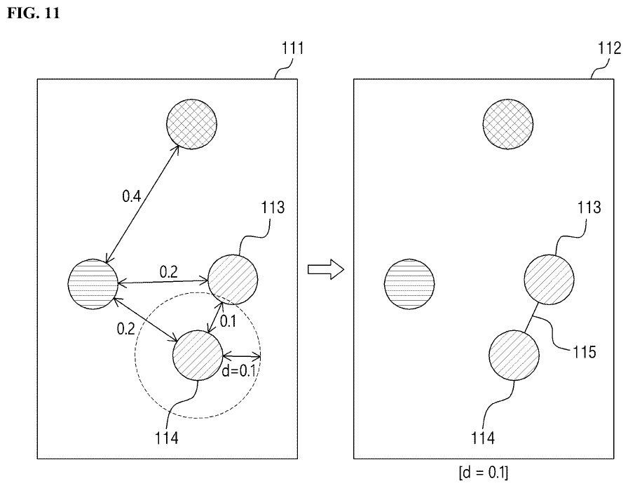

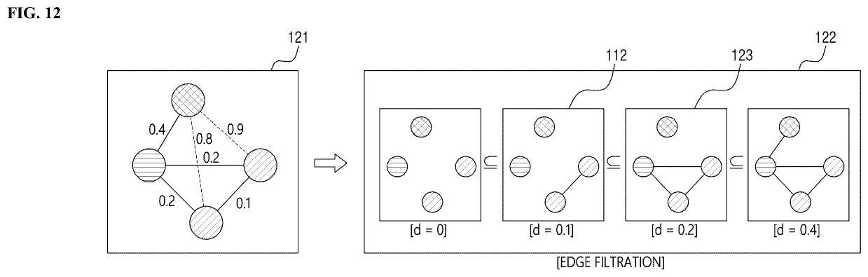

Specifically, in some embodiments, edge filtrations may be generated using the Vietoris-Rips filtration method. The Vietoris-Rips filtration method uses the distance between nodes as a connectivity metric to generate filtrations. Specifically, the Vietoris-Rips filtration method involves generating filtrations by repeatedly performing the step of connecting nodes that are closer than the value of the parameter, to generate subgraphs (particularly, simplicial complexes), while incrementally increasing the value of the parameter. The Vietoris-Rips filtration method is already well known to one of ordinary skill in the art to which the present disclosure pertains, and thus, a detailed description thereof will be omitted. In the embodiment of FIG. 5, the embedding system 10 may generate edge filtrations by repeating the process of connecting nodes with an edge weight less than or equal to the value of the parameter, while increasing the value of the parameter (i.e., using the edge weights as a connection (or distance) metric). For example, referring to FIG. 11, when the value of a parameter d is 0.1, the embedding system 10 may connect nodes that are within a distance less than the value of the parameter d, e.g., nodes 113 and 114 that are within a distance of 0.1, as indicated by reference numeral 115, to generate a subgraph 112 and repeat this process while increasing the value of the parameter d. As a result, referring to FIG. 12, an edge filtration 122 including the subgraph 112 of FIG. 11 and other subgraphs 123 that have an inclusion relationship with the subgraph 112 may be generated in an edge-weighted graph 121.

If the edge weights range between 0 and 1, the embedding system 10 may increase the value of the parameter d until it reaches about 0.5, 0.6, or 0.8, but the present disclosure is not limited thereto. Alternatively, in some embodiments, the embedding system 10 may increase the value of the parameter d until all edges of the color-weighted graph appear in subgraphs.

In some embodiments, a different filtration method from that previously mentioned may be used to generate edge filtrations. For example, the embedding system 10 may use the Cech (or offset) filtration method, among others, to generate edge filtrations. The Cech (or offset) filtration method is already well known to one of ordinary skill in the art to which the present disclosure pertains, and thus, a detailed description thereof will be omitted.

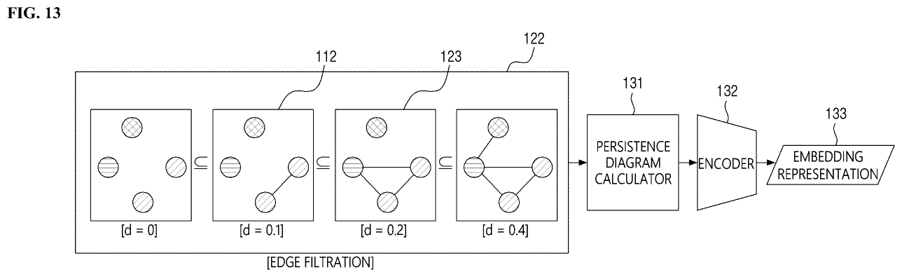

Referring back to FIG. 5, in step S54, an embedding representation of the target graph may be generated based on the topology information extracted from the edge filtrations. For example, referring to FIG. 13, the embedding system 10 may extract topology information by calculating persistent homology or a persistence diagram based on the edge filtration 122 via a persistence diagram calculator 131 (in this case, the result of the calculation may be used as the topology information), but the present disclosure is not limited thereto. That is, the embedding system 10 may extract the topology information in various other manners. Thereafter, the embedding system 10 may generate an embedding representation 133 of the target graph by encoding the topology information via an encoder 132.

The encoder 132 may be implemented in various manners. For example, if the topology information is in the form of a multi-set, the encoder 132 may be implemented as a neural network capable of embedding a multi-set (e.g., a neural network capable of converting a multi-set into vector form). Examples of such neural network include a deep set, a set transformer, etc., but the present disclosure is not limited thereto.

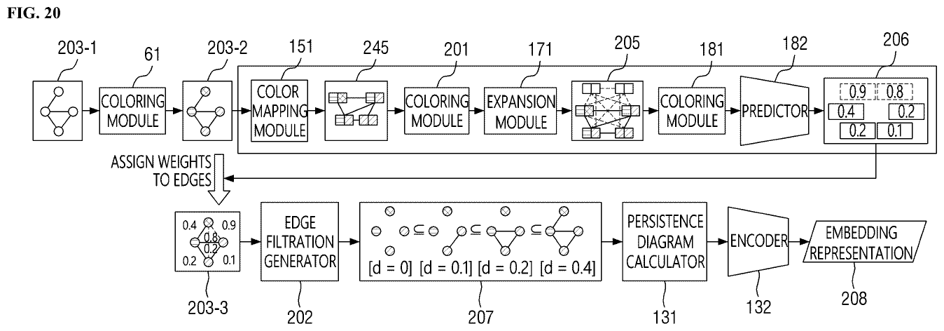

If the current stage is the embedding training stage, the embedding system 10 may perform a predefined task (e.g., a classification task, regression task, graph distinction task, etc.) based on the embedding representation (e.g., the embedding representation 133) of the target graph and may calculate a task loss. The method to calculate the task loss is not particularly limited. For example, for a classification task, a cross-entropy loss with the correct answer may be used as the task loss. Thereafter, the embedding system 10 may update the values of parameters for modules (e.g., the coloring module 61, the encoder 132, etc.) that have involved in generating the embedding representation, based on the task loss. This process may be repeated for numerous training graphs, allowing the corresponding modules (e.g., the coloring module 61, the encoder 132, etc.) to acquire an accurate embedding capability for graphs. This will be described later in further detail with reference to FIG. 20.

Conversely, if the current stage is the inference stage, the embedding system 10 may perform a predefined task (or a target task) based on the embedding representation (e.g., the embedding representation 133) of the target graph or may provide the corresponding embedding representation to a separate task execution device (not illustrated).

So far, the graph embedding method according to some embodiments of the present disclosure has been explained with reference to FIGS. 5 through 13. As described, edge weights may be calculated based on the node color values of the colored graph (i.e., the colored graph for the target graph), and edge filtrations may be generated using the edge weights as a connectivity metric. Then, an embedding representation of the target graph may be generated based on topology information extracted from the edge filtrations. In this case, an embedding representation that accurately reflects both node-centric and topology-centric information of the target graph may be generated. In other words, since edge filtrations may accurately capture the topological features (or information) of the target graph that node filtrations may have missed, the resulting embedding representation may have stronger expressive power than both the WL algorithm (or the graph embedding technique based on the neighboring node information aggregation method) and the node filtration-based graph embedding technique, and may universally improve the performance of various graph tasks.

A method that is applicable to step S52 of FIG. 5 will hereinafter be described with reference to FIGS. 14 through 19.

FIG. 14 is an example flowchart illustrating a method of calculating edge weights according to some embodiments of the present disclosure.

Referring to FIG. 14, in step S141, a line graph corresponding to a colored graph may be generated. The line graph is a graph having edges (or node tuples connected by edges) from an original graph as its nodes. That is, a particular edge (or node tuple) in the original graph becomes a particular node in the line graph, and edges adjacent to the particular node in the original graph serve as edges for the particular node in the line graph. The line graph is already well known to one of ordinary skill in the art to which the present disclosure pertains, and thus, a detailed description thereof will be omitted.

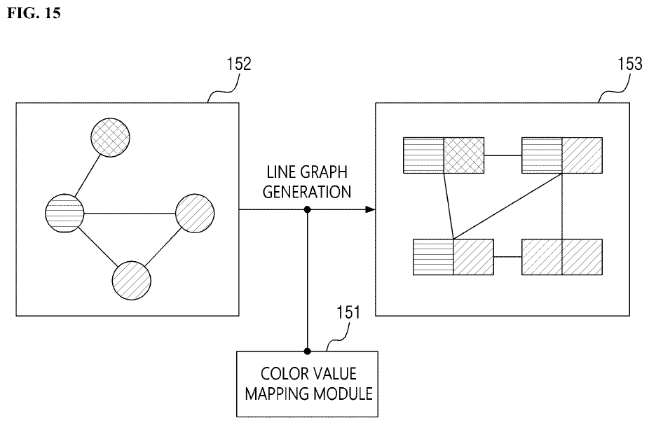

Specifically, referring to FIG. 15, the embedding system 10 may generate a line graph 153 corresponding to a colored graph 152. The embedding system 10 may obtain mapped color values by inputting the color values of node tuples (particularly, node tuples connected by edges) from the colored graph 152 into a color value mapping module 151, and may assign the mapped color values to nodes (i.e., nodes corresponding to the node tuples) in the line graph 153.

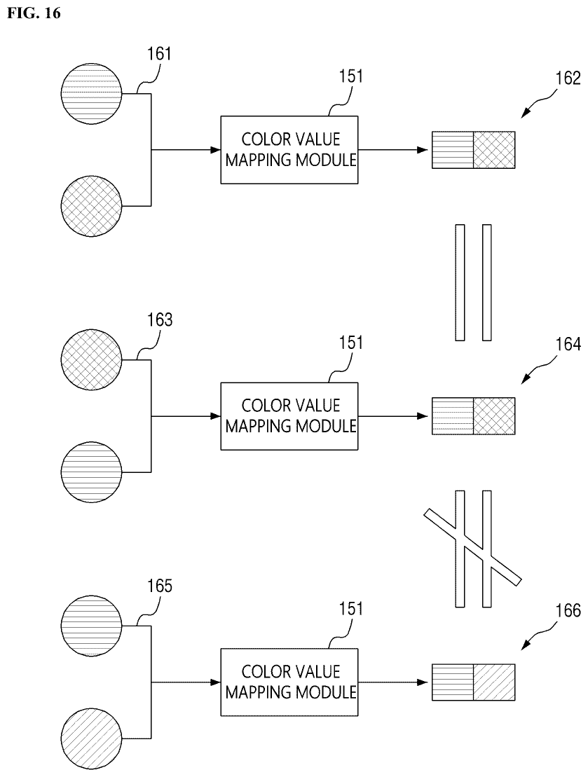

The color value mapping module 151 is a module configured to output the same mapping color value for node tuples with the same color values and different mapping color values for node tuples with different color values. For example, referring to FIG. 16, it is assumed that the color values of a first node tuple 161 are identical to the color values of a second node tuple 163 (without considering the order of the node color values) and the color values of a third node tuple 165 are different from the color values of each of the first and second node tuples 161 and 163. In this case, the color value mapping module 151 may output the same mapping color values, i.e., mapping color values 162 and 164 for the first and second node tuples 161 and 163, respectively, and a different mapping color value 166 from the mapping color values 162 and 164 for the third node tuple 165.

The color value mapping module 151 may be configured to calculate a mapping color value based on, for example, Equations 1 and 2 below. Specifically, the color value mapping module 151 may calculate first and second color values by inserting the color values of a node tuple (e.g., two node color values) into Equations 1 and 2, respectively. Then, the color value mapping module 151 may calculate a mapping color value based on the first and second color values, for example, by concatenating the first and second color values. Evidence has been provided by the inventor(s) of the present disclosure showing that this type of mapping color value exhibits characteristics exemplified in FIG. 16.

$$c 1 = ( x + η \cdot m ( x ) + y + η \cdot m ( y ) ) \qquad [ Equation 1 ]$$

$$c 2 = ( \vert x + η \cdot m ( x ) - y - η \cdot m ( y ) \vert ) \qquad [ Equation 2 ]$$

In Equations 1 and 2, c1 and c2 denote the first and second color values, respectively, x and y denote the color values of a node tuple, n represents a scalar value, which is a real number, and m represents a multi-layer perceptron. Both the scalar value n and the multi-layer perceptron m are learnable parameters that may be trained (or updated) during embedding training.

The multi-layer perceptron m may be understood as ensuring that a mapping function implemented by Equations 1 and 2 possesses the characteristics exemplified in FIG. 16 (considering the function approximation capability of the multi-layer perceptron m).

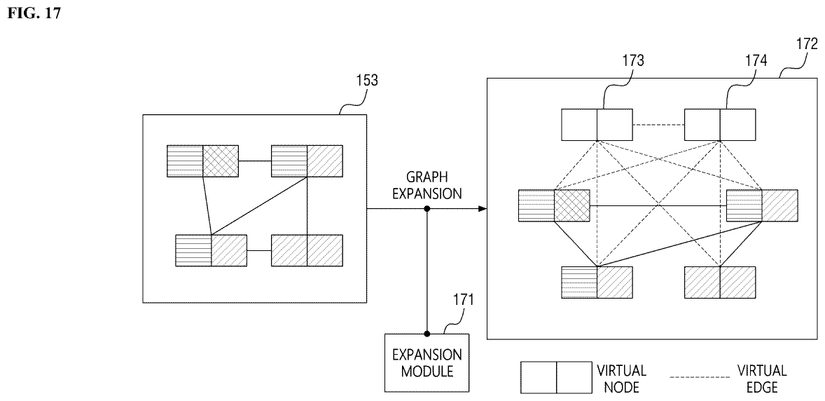

Referring back to FIG. 14, in step S142, an expanded line graph may be generated by adding virtual nodes and virtual edges to the line graph. For example, referring to FIG. 17, the embedding system 10 may generate an expanded line graph 172 by adding virtual nodes 173 and 174 with virtual edges through an expansion module 171 to the line graph 153. Additionally, the embedding system 10 may assign appropriate color values (e.g., null values, constant values, etc.) to the virtual nodes (e.g., the virtual node 173) via the expansion module 171. FIG. 17 illustrates the expanded line graph 172 as being a complete graph, but the present disclosure is not limited thereto. For example, the embedding system 10 (or the expansion module 171) may add predetermined numbers of virtual nodes and virtual edges to the line graph 153.

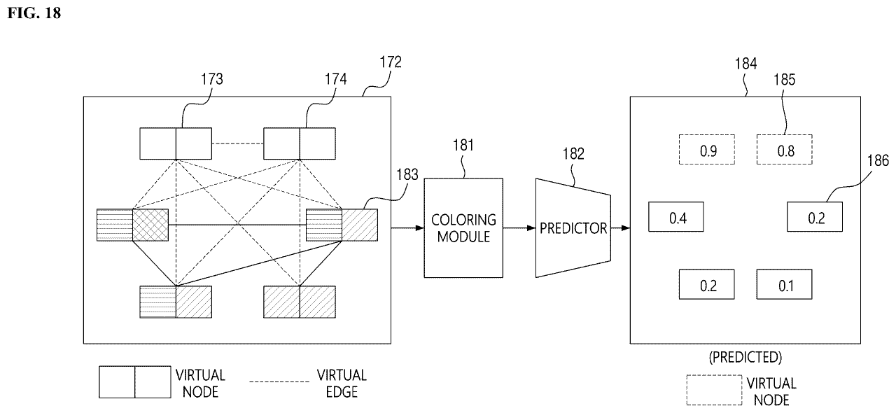

Here, the line graph may be expanded in step S142 to prepare for the training of a predictor (e.g., a predictor 182 of FIG. 18). Specifically, a training task of the predictor, which is a task of distinguishing between actual nodes and virtual nodes, necessitates the presence of virtual nodes for an accurate training of the predictor. Therefore, the method to expand the line graph in the inference stage (i.e., by adding virtual nodes and virtual edges) may differ from that in the training stage (e.g., the number and locations of added virtual nodes may vary), and step S142 may not be performed during the inference stage.

In step S143, the node color values of the expanded line graph may be updated by aggregating the color values of neighboring nodes. For example, referring to FIG. 18, the embedding system 10 may update the node color values of the expanded line graph 172 using a coloring module 181 (e.g., by executing the WL algorithm to update node color values). The coloring module 181 may be identical to or different from the coloring module 61 of FIG. 6.

The node color values of the expanded line graph may be updated to mix the color values of actual nodes and virtual nodes and thus to increase the task difficulty for the predictor 182.

In step S144, edge weights for the colored graph may be calculated based on the output values of the predictor for the node color values of the expanded line graph. Here, the predictor, which is a neural network that performs a task of distinguishing between actual nodes (i.e., actual edges of the colored graph) and virtual nodes (i.e., virtual edges of the colored graph), may be configured to output a score indicating whether each given node is an actual or virtual node based on its color values. The predictor may be implemented as a regressor or as a classifier performing binary classification. Step S144 will hereinafter be described in further detail with reference to FIG. 18.

Referring to FIG. 18, the embedding system 10 may calculate a score for the first node 174 by inputting the color values of a first node 174 of the expanded line graph 172 into the predictor 182, and may also calculate a score 186 for the second node 183 in a similar manner. FIG. 18 assumes the range of scores 184 between 0 and 1, with scores 184 closer to actual nodes being lower. However, if the predictor 182 is configured to output a probability value (i.e., a confidence score) indicating the probability of each given node being an actual node, then (1—Probability Value) (or the probability of each given node being a virtual node) may be used as a score (e.g., a score 185).

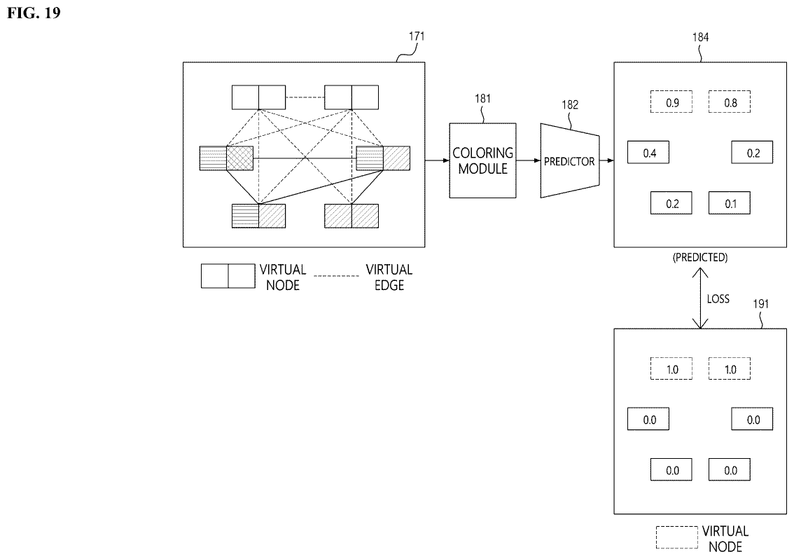

The predictor 182 may be trained based on the loss for the scores 184. For example, referring to FIG. 19, the embedding system 10 may update the parameters of the predictor 182 based on the loss between predefined correct answers 191 and individual scores 184. FIG. 19 illustrates an example where the correct answer 191 for actual nodes (i.e., actual edges of the colored graph) is set to 0 and the correct answer 191 for virtual nodes (i.e., virtual edges of the colored graph) is set to 1 (this may be understood as inducing the scores 184 to be lower, closer to actual nodes or actual edges of the colored graph, in consideration that the scores 184 are used as a type of distance metric).

So far, the method of calculating edge weights according to some embodiments of the present disclosure have been described with reference to FIGS. 14 to 19. According to this method, an expanded line graph is generated by adding virtual nodes and virtual edges to a line graph corresponding to a colored graph, and the predictor 182 is trained to forecast whether each node is an actual node (i.e., an actual edge of the colored graph) or a virtual node (i.e., a virtual edge of the colored graph) based on the node color values of the colored graph. Through the trained predictor 182, edge weights (e.g., values reflecting the associations between nodes) may be accurately calculated from the node color values of the colored graph.

Additionally, when generating the line graph, the node color values for the line graph may be accurately derived from the color values of the colored graph's node tuples through a multi-layer perceptron-based color value mapping module. Accordingly, edge weights may be more accurately calculated.

Furthermore, by updating the node color values of the expanded line graph through a coloring module (e.g., the WL algorithm) before predicting scores, the task difficulty of the predictor 182 may be increased, and as a result, the performance of the predictor 182 may be enhanced, allowing for a more accurate calculation of edge weights.

A graph embedding method according to some embodiments of the present disclosure will hereinafter be described with reference to FIG. 20. FIG. 20 illustrates an example where edge weights are calculated through the method described above with reference to FIGS. 14 through 19 and topology information is extracted through a persistence diagram. Each module depicted in FIG. 20 (e.g., a coloring module 61) may be understood as corresponding to a particular action/step/operation.

Referring to FIG. 20, when a target graph 203-1 is given, the embedding system 10 may acquire (or generate) a colored graph 203-2 for the target graph 203-1 through the coloring module 61 (hereinafter, the first coloring module 61).

Thereafter, the embedding system 10 may generate a line graph 245 corresponding to the colored graph 203-2. A color value mapping module 151 may be used to calculate the node color values of the line graph 245. The embedding system 10 may also update the node color values of the line graph 245 through a coloring module 201 (hereinafter, the second coloring module 201). The second coloring module 201 may be identical to or different from the first coloring module 61. For example, the first coloring module 61 may be a GNN-based module, and the second coloring module 201 may be a module that performs the WL algorithm. However, the present disclosure is not limited to this.

Thereafter, the embedding system 10 may generate an expanded line graph 205 from the line graph 245 through an expansion module 171.

In some embodiments, the embedding system 10 may also update the node color values of the expanded line graph 205 through a coloring module 181 (hereinafter, the third coloring module 181). The third coloring module 181 may be identical to or different from the first and second coloring modules 61 and 201. For example, the first coloring module 61 may be a GNN-based module, and the third coloring module 181 may be a module that performs the WL algorithm. However, the present disclosure is not limited to this.

Thereafter, the embedding system 10 may calculate individual scores 206 for the expanded line graph 205 through the predictor 182. The embedding system 10 may use the individual scores 206 as edge weights. That is, the nodes of the expanded line graph 205 correspond to the edges of the colored graph 203-2, and the scores 206 are assigned as edge weights for the corresponding edges. As a result, a color-weighted graph 203-3 for the target graph 203-1 may be generated.

Thereafter, the embedding system 10 may generate edge filtrations 207 from the color-weighted graph 203-3 through an edge filtration generator 202 using the edge weights as a connectivity metric. For example, the embedding system 10 may generate the edge filtrations 207 using the Vietoris-Rips filtration method (i.e., using the edge weights as a distance metric).

Thereafter, the embedding system 10 may extract topology information by calculating a persistence diagram based on the edge filtrations 207 through a persistence diagram calculator 131.

Thereafter, the embedding system 10 may generate an embedding representation 208 for the target graph 203-1 by encoding the topology information through an encoder 132.

Meanwhile, if the current phase is the embedding training phase, the embedding system 10 may perform a predefined task (i.e., a training task) based on the embedding representation 208 (e.g., input the embedding representation 208 into a task-specific layer to perform the predefined task). The type of the predefined task may vary, and multiple tasks may even be performed together. The embedding system 10 may calculate a loss (i.e., a task loss) based on the results of the performing of the predefined task and update the parameters of the modules that have involved in generating the embedding representation 208 (e.g., the first, second, and third coloring modules 61, 201, and 181, the predictor 182, the color value mapping module 151, the encoder 132, etc.) based on the task loss.

Alternatively, in some embodiments, the embedding system 10 may calculate a total loss by aggregating, for example, through a weighted sum of the task loss and a prediction loss based on the scores 206, and may update the parameters of the modules based on the total loss.

Additionally, if the current phase is the inference phase, the embedding system 10 may perform the predefined task (or the target task) based on the embedding representation 208. Alternatively, the embedding system 10 may also provide the embedding representation 208 to a separate task execution device (not illustrated).

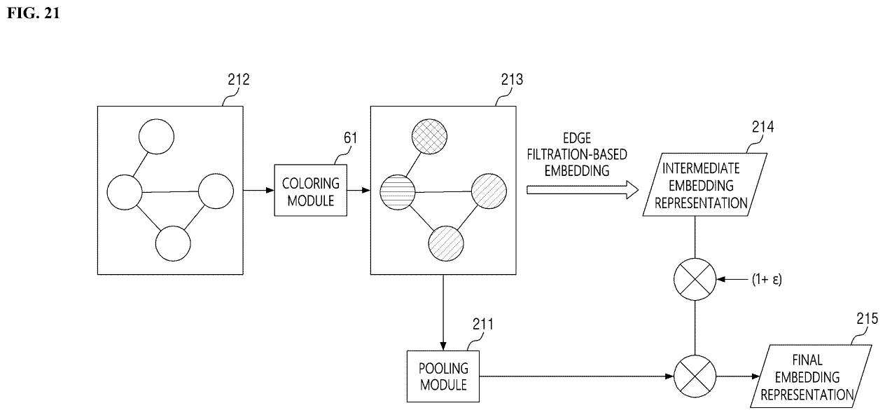

So far, the graph embedding method according to some embodiments of the present disclosure has been explained with reference to FIG. 20. A graph embedding method according to other embodiments of the present disclosure will hereinafter be described with reference to FIG. 21. For clarity, descriptions of content overlapping with the previous embodiments will be omitted.

FIG. 21 is an example diagram for explaining a graph embedding method according to other embodiments of the present disclosure.

The embodiment of FIG. 21 relates to a method for generating a final embedding representation of a target graph by aggregating an intermediate embedding representation (hereinafter, the first intermediate embedding representation) derived (or generated) based on edge filtrations and another intermediate embedding representation (hereinafter the second intermediate embedding representation) derived (or generated) from a colored graph.

Specifically, the embedding system 10 may acquire a colored graph 213 for a target graph 232 through a coloring module 61 and may generate a first intermediate embedding representation 214 from the colored graph 213 using the method described above with reference to FIG. 4. The first intermediate embedding representation 214 may correspond to, for example, the embedding representation 208 of FIG. 20.

Thereafter, the embedding system 10 may generate a second intermediate embedding representation (not illustrated) from the colored graph 213 through a pooling module 211. For example, the embedding system 10 may generate the second intermediate embedding representation by inputting data of the colored graph 213 (e.g., a matrix indicating node color values) into the pooling module 211. Here, any pooling method may be used. Various pooling methods are already well known to ordinary skill in the art to which the present disclosure pertains, and thus, detailed descriptions thereof will be omitted.

The pooling module 211 may also be referred to as a pooling layer, a readout layer, or a readout module.

Thereafter, the embedding system 10 may generate a final embedding representation 215 by aggregating the first intermediate embedding representation 214 and the second intermediate embedding representation. Specifically, the embedding system 10 may reflect a specific value such as, for example, (1+ε), in at least one of the first intermediate embedding representation 214 and the second intermediate embedding representation through, for example, multiplication, and aggregate the first intermediate embedding representation 214 and the second intermediate embedding representation through, for example, summation, to generate the final embedding representation 215. Here, the specific value may be reflected to prevent the first intermediate embedding representation 214 and the second intermediate embedding representation from canceling each other out during aggregation (e.g., summation). Cancellation of values implies the loss of some information (or expressive power) during aggregation. FIG. 21 illustrates an example where the final embedding representation 215 is generated by reflecting the specific value in the first intermediate embedding representation 214 through multiplication and aggregating the first intermediate embedding representation 214 and the second intermediate embedding representation through summation.

Meanwhile, the method to drive the specific value (e.g., ε or (1+ε)) may vary.

In some embodiments, the specific value may be a value set in advance. For example, the specific value, which is based on a hyperparameter ¿, may be determined in advance by a user. Specifically, the specific value may be set as an irrational number. Multiplying one (or both) of two intermediate embedding representations by an irrational number may effectively prevent the two intermediate embedding representations from canceling each other out during aggregation (e.g., addition). It has been mathematically proven by the inventor(s) of the present disclosure that the aggregation of two intermediate embedding representations through an irrational number-based multiplication operation and an addition operation may prevent information loss.

In other embodiments, the specific value may be a value derived based on a learnable parameter. For example, if the learnable parameter is ε, the specific value may also be ε or ε plus an irrational number. In this case, the embedding system 10 may update the value of the learnable parameter during embedding training. In this manner, an optimal value that minimizes the loss of information (or expressive power) during aggregation may be naturally and accurately derived.

In yet other embodiments, the specific value may be derived or generated based on various combinations of the aforementioned embodiments.

So far, the graph embedding method according to other embodiments of the present disclosure has been explained with reference to FIG. 21. According to this graph embedding method, a final embedding representation of a target graph may be generated by reflecting (e.g., through multiplication by an irrational number) a specific value in a first intermediate embedding representation derived based on topology information extracted from edge filtrations and then aggregating (e.g., through addition) the first intermediate embedding representation with a second intermediate embedding representation obtained from a colored graph. In this case, the specific value (e.g., an irrational number) may prevent the two intermediate embedding representations from canceling each other out during aggregation, minimizing information (or expressive power) loss during aggregation. As a result, an embedding representation of the target graph with enhanced node-centric information may be easily generated.

The results of experiments conducted by the inventor(s) of the present disclosure will hereinafter be described.

The inventor(s) conducted an experiment to compare the task performance of a proposed graph embedding method (hereinafter, the proposed method) with the task performance of a PPGN to verify the performance of the proposed method. Specifically, the inventor(s) performed a graph distinction task, a classification task, and a regression task for both the proposed method and the PPGN and compared the accuracy of the results. The graph embedding method of FIG. 21 was used as the proposed method, and the PPGN was utilized as the first coloring module 61. The WL algorithm was used as the second and third coloring modules 201 and 181.

For further details on the PPGN, which is a GNN that generates an embedding representation for a graph by aggregating neighboring node information (i.e., color values), please refer to the paper titled “Provably Powerful Graph Networks.”

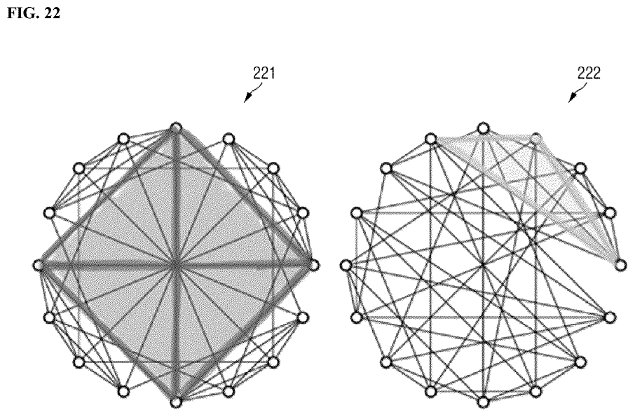

Firstly, after conducting embedding training, the inventor(s) performed a graph distinction task using a graph pair (221 and 222) of FIG. 22. Specifically, the inventor(s) of the present disclosure verified whether the proposed method and the PPGN generate different embedding representations for a pair of graphs 221 and 222 of FIG. 22. The results of the experiment are listed in Table 1 below.

TABLE 1

| Classification | Embedding Representations |
|---|---|
| PPGN | Identical |
| Proposed Method | Not Identical (Not Isomorphic) |

Referring to Table 1, the PPGN generated the same embedding representations for the graphs 221 and 222 because of not being able to distinguish between the first and second graphs 221 and 222, whereas the proposed method generated different embedding representations for the first and second graphs 221 and 222. It is noted that in FIG. 22, highlighted edges in each of the first and second graphs 221 and 222 are related to topological features the proposed method focused on to distinguish between the first and second graphs 221 and 222. This indicates that the performance (or expressive power) of the proposed method surpasses that of the PPGN (or the graph embedding technique based on the neighboring node information aggregation method, such as the WL algorithm), and also that embedding representations reflecting the topological (or structural) features of a graph may be generated through edge filtrations.

Then, the inventor(s) conducted a classification task to predict the classes of graphs using six datasets listed in Table 2. The six data sets are already well known in one of ordinary skill in the art to which the present disclosure pertains, and thus, detailed descriptions thereof will be omitted. The inventor(s) measured the accuracy of the classification task through a 10-fold cross-validation technique, and the results of the measurement are listed in Table 2 below.

TABLE 2

| Classifi- | | | | | IMDB- | IMDB- |
|---|---|---|---|---|---|---|
| cation | MUTAG | PTC | PROTEINS | NCI1 | B | M |
| PPGN | 88.88 | 64.7 | 76.39 | 81.21 | 72.2 | 44.73 |
| Proposed | 91.11 | 66.47 | 76.39 | 83.04 | 73.5 | 51 |
| Method | | | | | | |

Referring to Table 2, it may be observed that the performance of the proposed method surpasses that of the PPGN across all types of datasets for the classification task. This demonstrates that the proposed method may generate an embedding representation containing richer information than the PPGN and confirms that abundant topology information may be extracted through edge filtrations.

Lastly, the inventor(s) conducted a regression task predicting the values of 12 targets using the QM9 dataset. The QM9 dataset is already well known in one of ordinary skill in the art to which the present disclosure pertains, and thus, a detailed description thereof will be omitted. The inventor(s) utilized 80% and 10% of the QM9 dataset as training and validation sets, respectively, and the remaining 10% as a test set to measure the mean absolute error (MAE) for the regression task. The results of the measurement are listed in Table 3 below.

TABLE 3

| Target | PPGN | Proposed Method |
|---|---|---|
| μ | 0.231 | 0.09 |
| α | 0.382 | 0.19 |
| εₕₒₘₒ | 0.00276 | 0.00178 |
| εₗᵤₘₒ | 0.00287 | 0.0019 |
| Δε | 0.00406 | 0.00253 |
| <R²> | 16.07 | 3.47 |
| ZPVE | 0.00064 | 0.00032 |
| U₀ | 0.234 | 0.216 |
| U | 0.234 | 0.215 |
| H | 0.229 | 0.217 |
| G | 0.238 | 0.216 |
| Cᵥ | 0.184 | 0.081 |

Referring to Table 3, it may be seen that the performance of the proposed method surpasses that of the PPGN for the regression task, regardless of the type of target. This confirms that the proposed method may generate an embedding representation containing richer information than the PPGN and that abundant topology information may be extracted through edge filtrations. Furthermore, it demonstrates that the proposed method may universally improve the performance of various graph tasks.

So far, the performance experiment results for the method proposed by the inventor(s) have been briefly described. An example computing device 230 capable of implementing the embedding system 10 will hereinafter be described with reference to FIG. 23.

FIG. 23 is a hardware configuration view illustrating an example computing device 230 that may implement the document comparison system according to some embodiments of the present disclosure.

Referring to FIG. 23, the computing device 230 may include at least one processor 231, a bus 233, a communication interface 234, a memory 232, which loads a computer program 236 executed by the processor 231, and a storage 235 that stores the computer program 236. Even though FIG. 23 depicts only components related to the embodiments of the present disclosure, it is obvious to one of ordinary skill in the art to which the present disclosure pertains that the computing device 230 may further include other generic components, in addition to the components depicted in FIG. 23. Moreover, in some embodiments, the computing device 230 may be configured with some of the components depicted in FIG. 23 omitted. The components of the computing device 230 will hereinafter be described.

The processor 231 may control the overall operation of each of the components of the computing device 230. The processor 231 may be configured to include at least one of a central processing unit (CPU), a micro-processor unit (MPU), a micro-controller unit (MCU), a graphics processing unit (GPU), or any form of processor well-known in the field of the present disclosure. Additionally, the processor 231 may perform computations for at least one application or program to execute operations/methods according to some embodiments of the present disclosure. The computing device 230 may be equipped with one or more processors.

The memory 232 may store various data, commands, and/or information. The memory 232 may load the computer program 236 from the storage 235 to execute the operations/methods according to some embodiments of the present disclosure. The memory 232 may be implemented as a volatile memory such as a random-access memory (RAM), but the present disclosure is not limited thereto.

The bus 233 may provide communication functionality between the components of the computing device 230. The bus 233 may be implemented in various forms such as an address bus, a data bus, and a control bus.

The communication interface 234 may support wired or wireless Internet communication of the computing device 230. Additionally, the communication interface 234 may also support various other communication methods. To this end, the communication interface 234 may be configured to include a communication module well-known in the technical field of the present disclosure.

The storage 235 may non-transitorily store at least one computer program 236. The storage 235 may be configured to include a non-volatile memory such as a read-only memory (ROM), an erasable programmable ROM (EPROM), an electrically erasable programmable ROM (EEPROM), a flash memory, as well as a computer-readable recording medium in any form well-known in the technical field of the present disclosure, such as a hard disk or a removable disk.

The computer program 236, when loaded into the memory 232, may include one or more instructions that enable the processor 231 to perform the operations/methods according to some embodiments of the present disclosure. That is, by executing the loaded one or more instructions, the processor 231 may perform the operations/methods according to some embodiments of the present disclosure.

For example, the computer program 236 may include instructions for performing operations of: acquiring a colored graph for a target graph; calculating edge weights for the colored graph based on node color values of the colored graph; generating edge filtrations for the colored graph using the edge weights as a connectivity metric between nodes; and generating an embedding representation of the target graph based on topology information extracted from the edge filtrations.

As another example, the computer program 216 may include instructions to perform at least some of the steps/operations described above with reference to FIGS. 1 through 22.

In this example, the computing device 230 may implement the embedding system 10 according to some embodiments of the present disclosure.

Meanwhile, in some embodiments, the computing device 230 of FIG. 23 may refer to a virtual machine implemented based on cloud technology. For example, the computing device 230 may be a virtual machine operating on one or more physical servers included in a server farm. In this example, at least some of the processor 231, the memory 232, and the storage 235 may be virtual hardware, and the communication interface 234 may also be implemented as a virtualized networking element such as a virtual switch.

The computing device 230 that may implement the embedding system 10 according to some embodiments of the present disclosure has been described so far with reference to FIG. 23.

Various embodiments of the present disclosure and their effects have been mentioned thus far with reference to FIGS. 1 through 23.

According to the aforementioned and other embodiments of the present disclosure, edge weights may be calculated based on the node color values of a colored graph (i.e., a colored graph for a target graph), and edge filtrations may be generated using the edge weights as a connectivity metric. Based on topology information extracted from the edge filtrations, an embedding representation of the target graph may be generated. In this case, an embedding representation that accurately reflects both node-centric information and topology-centric information of the target graph may be produced. In other words, since edge filtrations may accurately capture the topological features (or information) of the graph that node filtrations may miss, the generated embedding representation may have stronger expressive power than both the WL algorithm (or a graph embedding technique based on the neighboring node aggregation method) and a node filtration-based graph embedding technique, and may universally improve the performance of various graph tasks.

Furthermore, by adding virtual nodes and edges to a line graph corresponding to the colored graph to generate an expanded line graph, and training a predictor to predict scores indicating whether each node corresponds to an actual node (i.e., an actual edge of the colored graph) or a virtual node (i.e., a virtual edge of the colored graph) based on the node color values of the expanded line graph, edge weights (e.g., values reflecting the associations between nodes) may be accurately calculated from the node color values of the colored graph.

Additionally, during the generation of a line graph, the node color values of the line graph may be accurately derived from the color values of the node tuples of the colored graph through a multi-layer perceptron-based color value mapping module, allowing for a more accurate calculation of the edge weights.

Also, by updating the node color values of the expanded line graph through a coloring module (e.g., the WL algorithm) before predicting scores, the difficulty of the task performed by the predictor may be increased, resulting in improved performance of the predictor and a more accurate calculation of the edge weights.

Moreover, by calculating a persistence diagram from edge filtrations, the topology information of the graph may be accurately extracted.

Additionally, by reflecting (e.g., through multiplication by an irrational number) a specific value in a first intermediate embedding representation generated based on the topology information extracted from edge filtrations, and then aggregating (e.g., through addition) the first intermediate embedding representation with a second intermediate embedding representation obtained from the colored graph, a final embedding representation of the target graph may be generated. In this case, the specific value (e.g., an irrational number) may prevent the two intermediate embedding representations from canceling each other out during aggregation, minimizing information (or expressive power) loss during aggregation. As a result, an embedding representation of the target graph with enhanced node-centric information may be easily generated.

Furthermore, the specific value may be derived based on a learnable parameter. In this case, as embedding training progresses, an optimal value that minimizes the loss of information (or expressive power) during aggregation may be naturally and accurately derived.

The effects according to the technical idea of the present disclosure are not limited to those mentioned above, and other effects not mentioned may be clearly understood by one of ordinary skill in the related art from the description below.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results may be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications may be made to the example embodiments without substantially departing from the principles of the present disclosure. Therefore, the disclosed example embodiments of the disclosure are used in a generic and descriptive sense only and not for purposes of limitation.

What is claimed is:

1. A method for embedding a graph performed by at least one processor, the method comprising:
acquiring a colored graph for a target graph;
calculating an edge weight for the colored graph based on node color values of the colored graph;
generating an edge filtration for the colored graph using the edge weight as a connectivity metric between nodes; and
generating an embedding representation of the target graph based on topology information extracted from the edge filtration.

2. The method of claim 1, wherein the colored graph is generated by updating a color value of each node that forms the target graph, in a manner that aggregates color values of neighboring nodes.

3. The method of claim 1, wherein the calculating the edge weight comprises:
generating a line graph corresponding to the colored graph, node color values of the line graph being determined based on color values of a node tuple connected by a corresponding edge in the colored graph; and
calculating an edge weight for a first edge of the colored graph corresponding to a first node in the line graph based on a color value of the first node.

4. The method of claim 3, wherein the calculating the edge weight for the first edge comprises determining the edge weight for the first edge based on an output value of a predictor that is obtained by inputting the color value of the first node, and
the predictor is configured to output a score indicating whether an edge of the colored graph corresponding to an input node is an actual edge or a virtual edge, based on a color value of the input node.

5. The method of claim 4, wherein a training process of the predictor comprises:
generating an expanded line graph by adding a virtual node and a virtual edge to a training line graph;
calculating a score, based on a color value of each node in the expanded line graph, indicating whether a corresponding edge in the expanded line graph is an actual edge or a virtual edge; and
updating the predictor based on a loss associated with the calculated score.

6. The method of claim 5, wherein the expanded line graph is a complete line graph.

7. The method of claim 3, wherein the generating the line graph comprises:
acquiring a mapping color value for color values of a first node tuple connected by the first edge through a color value mapping module; and
assigning the mapping color value to the first node, and
the color value mapping module is configured to output the same color value as a particular mapping color value mapped to particular color values when the color values of the first node tuple are equal to the particular color values, and to output a different color value from the particular mapping color value when the color values of the first node tuple are different from the particular color values.

8. The method of claim 3, wherein the generating the line graph comprises:
calculating a first color value according to Equation 1 below and a second color value according to Equation 2 from color values of a first node tuple connected by the first edge;
determining a mapping color value for the first node tuple based on the first and second color values; and
assigning the mapping color value to the first node, and
$$c 1 = ( x + η \cdot m ( x ) + y + η \cdot m ( y ) ) \qquad [ Equation 1 ]$$
$$c 2 = ( \vert x + η \cdot m ( x ) - y - η \cdot m ( y ) \vert ) \qquad [ Equation 2 ]$$
where c1 and c2 are the first color value and the second color value, respectively, x and y are the color values of the first node tuple, n denotes a scalar value, which is a real number, and m represents a multi-layer perceptron.

9. The method of claim 1, wherein the calculating the edge weight for the colored graph comprises:
generating a line graph corresponding to the colored graph, node color values of the line graph being determined based on color values of node tuples connected by corresponding edges in the colored graph;
generating an expanded line graph by adding a virtual node and a virtual edge to the line graph;
updating a node color value of the expanded line graph by aggregating color values of neighboring nodes; and
calculating an edge weight for a first edge of the colored graph corresponding to a first node in the expanded line graph based on the updated color value of the first node.

10. The method of claim 1, wherein the generating the edge filtration comprises generating the edge filtration using a Vietoris-Rips filtration technique.

11. The method of claim 1, wherein the generating the embedding representation of the target graph comprises extracting the topology information by calculating a persistence diagram based on the edge filtration.

12. The method of claim 11, wherein the topology information is information in a form of a multi-set, and
the generating the embedding representation of the target graph further comprises generating the embedding representation of the target graph by encoding the topology information through a neural network-based encoder equipped with an embedding capability for the multi-set.

13. The method of claim 1, wherein the generating the embedding representation of the target graph comprises:
deriving a first intermediate embedding representation for the target graph based on the topology information;
deriving a second intermediate embedding representation for the target graph based on the node color values of the colored graph; and
generating the embedding representation of the target graph by aggregating the first intermediate embedding representation and the second intermediate embedding representation.

14. The method of claim 13, wherein the generating the embedding representation of the target graph by aggregating the first and second intermediate embedding representations comprises aggregating the first intermediate embedding representation and the second intermediate embedding representation by reflecting a specific value in at least one of the first intermediate embedding representation and the second intermediate embedding representation, and
the specific value is an irrational number.

15. The method of claim 13, wherein
the generating the embedding representation of the target graph by aggregating the first and second intermediate embedding representations comprises aggregating the first intermediate embedding representation and the second intermediate embedding representation by reflecting a specific value in at least one of the first intermediate embedding representation and the second intermediate embedding representation,
the specific value is based on a learnable parameter, and
a value of the learnable parameter is updated by performing a predefined task based on the generated embedding representation.

16. The method of claim 1, further comprising:
calculating a task loss by performing a predefined task based on the generated embedding representation; and
updating values of parameters involved in the generating the embedding representation based on the task loss.

17. A system for embedding a graph, the system comprising:
at least one processor; and
a memory configured to store a computer program that is executed by the at least one processor,
wherein the computer program comprises instructions for performing:
acquiring a colored graph for a target graph;
calculating an edge weight for the colored graph based on node color values of the colored graph;
generating an edge filtration for the colored graph using the edge weight as a connectivity metric between nodes; and
generating an embedding representation of the target graph based on topology information extracted from the edge filtration.

18. A non-transitory computer-readable recording medium having stored therein a computer program executing a method for embedding a graph, the method comprising:
acquiring a colored graph for a target graph;
calculating an edge weight for the colored graph based on node color values of the colored graph;
generating an edge filtration for the colored graph using the edge weight as a connectivity metric between nodes; and
generating an embedding representation of the target graph based on topology information extracted from the edge filtration.
